(19) United States
(12) Patent Application Publication
(10) Pub. No.: US 2008/0115534 A1
(43) Pub. Date: May 22, 2008

(54) Preforms for Creating Decorative Fused Glass

(76) Inventor: Melvin Craig Kernan, Enumclaw, WA (US)

Correspondence Address: Melvin Craig Kernan, 1229 Garfield Street, Enumclaw, WA, 98022, US

(21) Appl. No.: 11/561,398

(22) Filed: Nov. 19, 2006

(51) Int. Cl. C03B 23/20

(52) U.S. Cl. 65/36; 428/542.8

(57) ABSTRACT

Coordinated preforms made of COE (coefficient of expansion) compatible glass are shaped for making predictable decorative patterns in fused glass. When color design preforms 40, 50, 60 are positioned using the indentations 11, 31 in base sheet preforms 10, 20, 30 they will deform into predictable mosaic patterns when the arrangement is fused together.

### CROSS-REFERENCE TO RELATED APPLICATIONS

Not Applicable

### FEDERALLY SPONSORED RESEARCH

Not Applicable

### SEQUENCE LISTING OF PROGRAM

Not Applicable

### FIELD OF INVENTION

This invention relates to making fused glass objects used as decorative art, architectural glass, wall tiles, and objects to be further processed into stained glass or slumped glass objects.

### BACKGROUND OF THE INVENTION

Artistic and decorative glass objects can be made by fusing (melting together) glass pieces of various colors. To make such decorative objects pieces of glass are placed together, often overlapping, and fused into a single usually relatively flat glass object in a kiln.

Glass fused into such decorative objects can be used as stand alone artistic pieces, elements of stained glass objects such as church windows or glass lamp shades, architectural tiles and other objects. After fusing the resulting glass object are sometimes slumped (heated to softening and shaped by gravity) into a shaped mold to make plates, bowls and other 3 dimensional shaped objects. Fused glass objects are also used as components for other glass projects. Two books by Boyce Lindstrom “Kiln Fired Glass” and “Advanced Fusing Techniques provide a good overview of current glass fusing and related techniques.

The glass used to make fused glass objects typically consist of shapes cut from flat glass sheets. Sometimes rod of various diameters (often called noodles or stringers), or frit (broken up small pieces of glass available in various grits) are also used. Obtaining predictable results with these elements requires skill and experience since the pieces of glass are deformed by gravity and surface tension as they are melted together.

The glass pieces used to make fused glass objects should be of matching COE (coefficient of expansion) to prevent the buildup of stresses from differential contraction as the glass cools after the pieces are melted together. This is particularly important on larger fused pieces. Using glass components with insufficiently matched COE can result in high level of stress and pieces that fracture when cooling or are handled. COE matched clear and colored glass is available commercially in flat glass sheets, rods and frit.

Melted glass tends to even out to a thickness of about 6 mm. At this thickness the forces of gravity spreading out the glass are approximately balanced cohesive forces. Consequently, glass fused to about this thickness will exhibit less unpredictable distortion.

Creating fused glass objects is a two stage process. The first step is layout. Layout includes cutting the glass pieces into shapes and arranging these pieces in a pattern. The second step is fusing. Fusing heats the glass arrangement in a kiln to a sufficient temperature to melt the glass together. The two processes, arranging and fusing, require different skills and are sometimes done by different people. The results depend on both the layout and the temperature profile used to fuse it.

Current methods of making fused glass objects have several disadvantages. These include:

(a) Considerable skill is required to cut glass shapes and arrange them so as to obtain reasonably predictable results for anything except very simple patterns. This makes it difficult for novice or even experienced glass craftsmen to obtain the results they plan.

(b) Cutting glass and working with cut glass requires care and involves an element of danger. Cut and broken glass pieces have sharp edges that can cause serious cuts. Working with frit and cutting glass present the additional danger from small airborne particle that can cause lung and eye damage.

(c) Care must be exercised in moving a laid out pattern of glass pieces from the place where they are arranged to the kiln or to a temporary storage location. The pieces of glass can easily shift changing their arrangement when bumped or tipped. An adhesive that evaporates in the kiln can be used to hold the pieces in place. This, however, introduces additional layout steps and makes it difficult to change layout or correct an error.

(d) The infinite variety of potential cut glass shapes, the infinite possible arrangement of the pieces, and the dependence of the result on the temperature profile used in fusing the glass make it extremely difficult to produce CAD (computer aided design) software to aid in the design of fused glass objects.

(e) Producing fused glass objects having regular mosaic patterns is difficult and time consuming because it requires precision cutting and placing of many glass pieces. This is particularly true of larger mosaic patterns composed of small mosaic elements.
Note: Glass artists have made very small mosaic patterns called millefiori (Italian for thousand flowers) for centuries. Millefiori are made by gathering rods of glass together in a bundle, fusing the bundled components together and then breaking off, or cutting off with a diamond saw, small flat pieces with a mosaic patterns. Because of the difficulty in making larger millefiori they are seldom much bigger than 1 cm in diameter. Millefiori are are most commonly used as decorations fused to the surface of glass beads.

(f) For other than very simple designs making multiple fused objects with the same design is difficult and labor intensive. Making accurate multiple copies of complex fused glass designs is almost impossible.

(g) The variety of shaped pieces used in making fused glass objects make it difficult to assemble fused glass arrangements with robotic tools. Robotic equipment to cut even relatively simple shapes is very expensive. Designing robotic systems to manipulate a wide variety of shapes is very difficult. Furthermore, the sharp cut glass edges and chips can cut the soft suction cups normally used by robots to handle smooth flat objects.

### OBJECTIVES AND ADVANTAGES

The objectives of the inventions are:
(a) Enable the creation of visually complex fused glass objects with predictable results.
(b) Enable the creation of complex mosaic color patterns in fused glass without precision cutting of glass pieces.
(c) Reduce the danger in laying out fused glass objects.
(d) Facilitate moving and storing of laid out, or partially laid out fused glass pattern prior to fusing without disrupting the arrangements.
(e) Enable the creation of complex fused glass projects without cutting glass or skill in positioning cut glass pieces. This would bring the layout of fused glass projects within the range of novice hobbyists.
(f) Enable the creations of a variety of regular mosaic patterns in fused glass without cutting small glass pieces.
(g) Separate the design and manufacturing processes allowing designers without glass skills to create designs to be implemented by others.
(h) Facilitate the layout or partial layout of fused glass patterns with robotic equipment.
(i) Enable the planning of fused glass designs using standardized layout sheets.
(j) Facilitate the development of CAD (computer aided design) tools for the design of fused glass objects.
(k) Simplify the production of individual fused glass objects with standard dimensions for projects requiring fixed sizes such as wall tiles and stained glass lamp shades panes.
(l) Make it easy to create multiple fused glass objects with the same pattern, for example to create a matching set of fused glass windows, glass dishes or decorative glass tiles.

### DRAWINGS—FIGURES

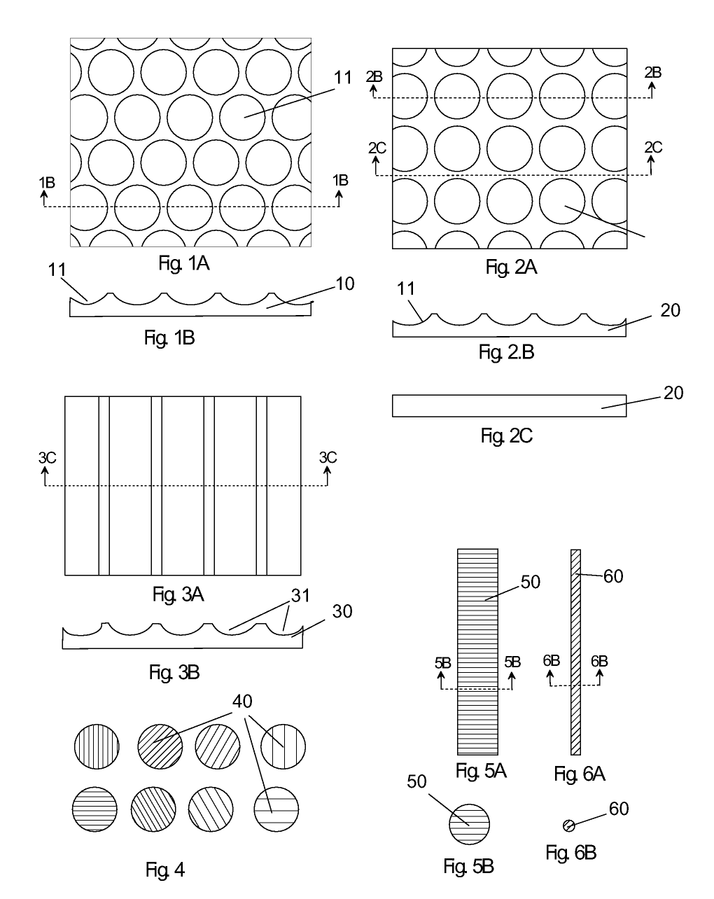

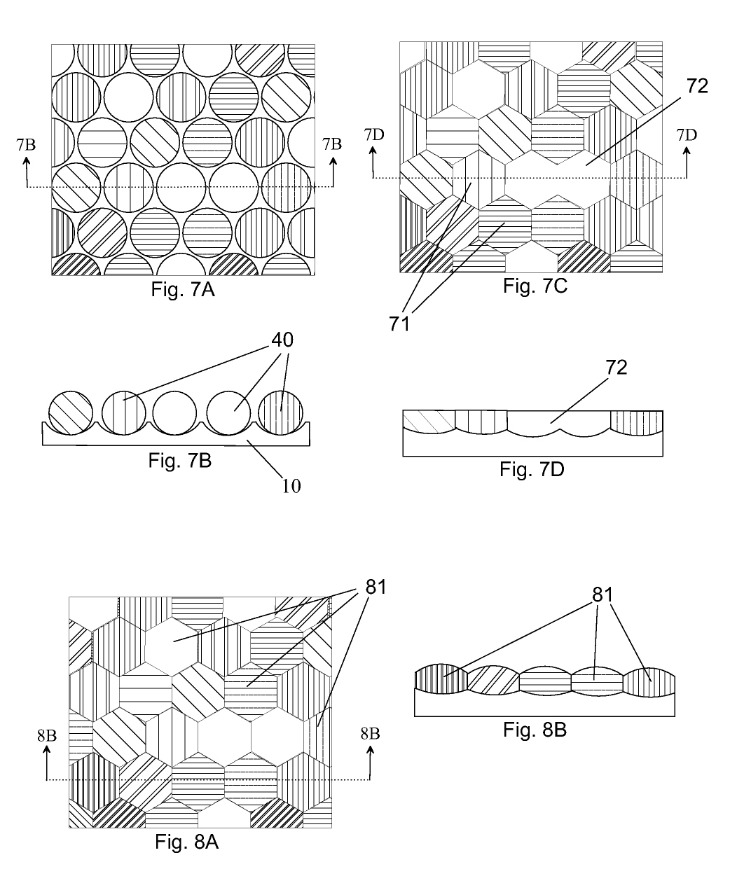

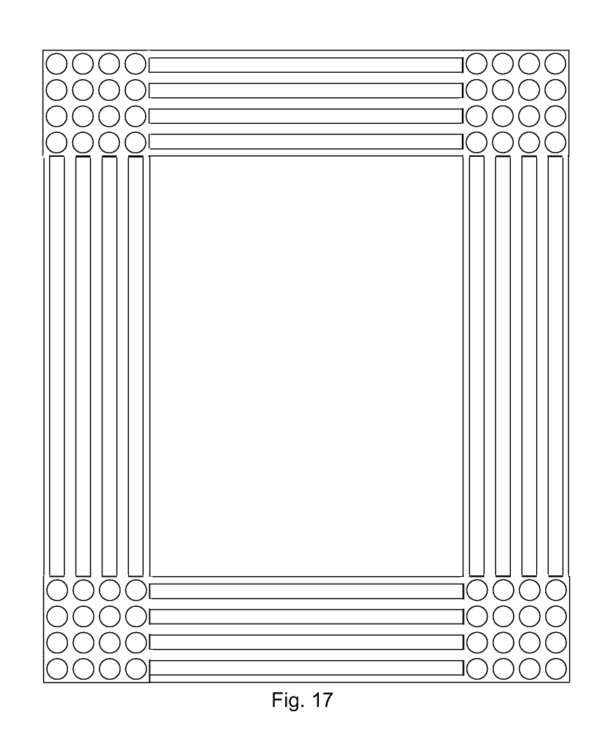

In the drawings, closely related figures have the same number but different alphabetic suffixes. FIGS. 1A through 6B show glass preforms or portions of glass preforms used in the preferred embodiment. FIGS. 7A through 16 illustrate some ways of using the preferred embodiment preforms to create decorative fused glass objects or parts thereof. FIGS. 17 to 28 illustrate other embodiments. FIGS. 29A to 31 illustrate a two layer layout sheet embodiment for planning and layout of fused glass designs.

### REFERENCE NUMERALS

Note that reference numbers ending in 0 refer to entire object. Other final digits refer to parts of objects. The initial digit(s) indicate the Fig. number where it first appears.
10 Hexagonal Grid Base Sheet
11 Indentation for positioning ball preforms
20 Rectangular Grid Base Sheet
30 Parallel Trough Base Sheet
31 Trough indentation
40 Ball Preforms
50 Thick Rod Preform
60 Thin Rod Preform
71 Hexagonal Element after Fusing
72 Hexagonal Elements of the Same Color Fused into Seamless Visual Element.
81 Hexagonal Lens Elements
91 Rectangular Element after Fusing
181 Raised Edge
220 Example of base sheet to use with flat color preforms
230 Octagonal flat color preform
240 Rounded square flat color preform
260 “Grouting” preform
261 Hole in grouting preform
262 Carrier without pigment
263 Carrier with pigment
281 Color design preform after fusing
291 Cell of design sheet colored in by designer
301 Opaque part of layout overlay sheet
302 Transparent part of layout overlay sheet
311 Portion of colored in segment showing through overlay sheet

### EMBODIMENTS

The preferred embodiment consists of a set of six glass preform designs (10, 20, 30, 40, 50, 600 that can be used in combinations to create a wide variety of decorative fused glass objects with predictable results. These glass preforms fall into two categories base sheet preforms (FIGS. 1A through 3B) and color design preforms (FIGS. 4 through 6B). Base sheet preforms 10, 20, 30 have indentations for positioning color design preforms 40, 50, 60.

The base sheet preforms are relatively flat sheets of glass having patterns of indentahons. They are made with glass having the same specified COE (coefficient of expansion). Three base sheet preforms are employed in the preferred embodiment. Each has a repeating pattern of indentations. The three base sheet preforms are:
hexagonal grid base sheets 10, a section of which is illustrated in FIGS. 1A and 1B,
rectangular grid base sheets 20, a section of which is illustrated in FIGS. 2A, 2B and 2C.
parallel trough base sheets 30, a section of which is illustrated in FIGS. 3A and 3B.

### For a specific fused glass project base sheet preforms may be either pre-made to the desired outline or cut from a larger sheet of base sheet preform.

Color design preforms are made in standard shapes that are COE compatible with the base sheet preform glass. They are made of glass in a variety of colors. These colors could include water clear, transparent colors, translucent colors, and opaque colors. Color design preforms for the preferred embodiment have three shapes:
ball preforms 40 illustrated in FIG. 4,
thick rod preforms 50 illustrated in FIGS. 5A, 5B and 5C, and
thin rod preforms 60 illustrated in FIGS. 6A,B.

### Note that ball shapes are easily moved with robotics.

The indentations 11 in the hexagonal grid base sheet 10 and rectangular grid base sheet 20 preforms are intended for the positioning of ball preforms 40. The center to center spacing in both the hexagonal grid pattern (FIG. 1A) and the rectangular grid pattern (FIG. 2A) are both about 6.3 mm (1/4 inch). The average thickness of the base sheets being about 3mm. The balls (FIG. 4) having a diameter of approximately 6 mm are designed to be positioned using these indentations. With these dimensions the balls placed in adjoining base sheet indentations will have just a little space between them.

A parallel trough base sheet 30 (FIGS. 3A and 3B) also has an average thickness of approximately 3mm. The indentations 31 in the parallel trough preform are parallel troughs. These troughs are intended for positioning of thick rod preforms 50, thin rod performs 60, or combinations of the two. The indentation in the parallel grid preform are spaced approximately 6.3 mm center to center. The thick rod preforms 50 have a diameter of approximately 5 mm. The thin rod preforms 60 have a diameter of approximately 1 mm. With these dimensions a thick rod could be placed in adjacent parallel grid indentation. One or more thin rods could be place in a single parallel trough indentation. The indentations in a parallel grid preform could be used to position rods of almost any diameter. These dimensions were chosen so that filling all troughs with thick rod preforms would result in glass approximately 6 mm thick. One or more thin rod preforms placed under a thick rod preform would add very little (approximately 0.12 mm each) thickness.

This embodiment enables the creation of fused glass objects having elements from one or more of the following groups of pattern:
patterns that can be created using a hexagonal grid base sheet 10 and ball preforms 40, (Some of these are illustrated in Examples 1.1, 1.2 and 1.3.)
patterns that can be created using a rectangular grid base sheet 20 and ball preforms 40, (Some of these are illustrated in Examples 1.4 and 1.5.)
Patterns of parallel lines of various widths that can be created using a parallel trough base sheet 30 with thick rod preforms 50, thin rod preforms 60 or a combination of both. (Some of these are illustrated in Example 1.5.)

Examples follow illustrating some of the potential uses of these preforms to create designs or parts of designs in fused glass objects. Note that hatching patterns are used to represent different colors of glass unless indicated otherwise.

### EXAMPLE 1.1

### Using a Hexagonal Grid Base Sheet and Ball Preforms to Create a Fused Glass Object having a Mosaic Pattern of Small Hexagons. (FIGS. 7A Through 7D)

The preforms are used in the following way:

The ball preforms 40 are placed in the indentations of the hexagonal grid base sheet 10 in the color arrangement desired in the fused glass mosaic object to be made. FIGS. 7A and 7B shows a part of such an arrangement. The placement of colors could be planned with design sheets, planned with computer graphics, or inspired as the balls are placed.

The combination of the hexagonal base sheet and ball preforms as arranged above is heated in a kiln to fuse all these preforms together into a single relatively flat decorative glass object (FIG. 7D). As glass balls melt they are deformed by gravity and spread out to meet one another forming a mosaic of hexagons 71. Note that neighboring elements of the same color fuse together seamlessly into a single element 72. The ball preforms fuse together with both their neighbors and the base sheet. After fusing the glass object is cooled to room temperature.
Note: A wide variety of inter-indentation spacings and ball diameters can be used in this arrangement. These dimensions were chosen so as to fuse into a standard thickness of approximately 6 mm and to minimize undesired distortion in the fusing process.
The actual preform dimensions will be determined by manufacturing and marketing considerations.

### EXAMPLE 1.2

### Using a Hexagonal Grid Base Sheet and Ball Preforms to Create a Fused Glass Object Having a Mosaic Pattern of Hexagonal Lenses. (FIGS. 7A, 7B, 8A and 8B)

Using the same preforms proceed as in example 1.1 above except using somewhat less heating (lower peak temperature or shorter duration at high temperature) in the kiln. The balls when heated somewhat less do not flatten out completely but retain a domed form 81 (FIGS. 8A and 8B) that refracts light in the manner of a small colored lens.

When viewing a scene through such a fused glass object each small lens shows a miniature inverted image of the scene colored by the color of the glass. The resulting array of small images colored by the various glass elements can be quite striking
Note that the combination of gravity and surface tension effects will shape a variety of raised forms into rounded domed structures. Thus, the ball preforms 40 need not be spherical. For glass objects less than about 10 mm surface tension effects have a strong tendency to form raised objects into rounded domes. Thus other shapes will also form lens like elements.

### EXAMPLE APPLICATION 1.3

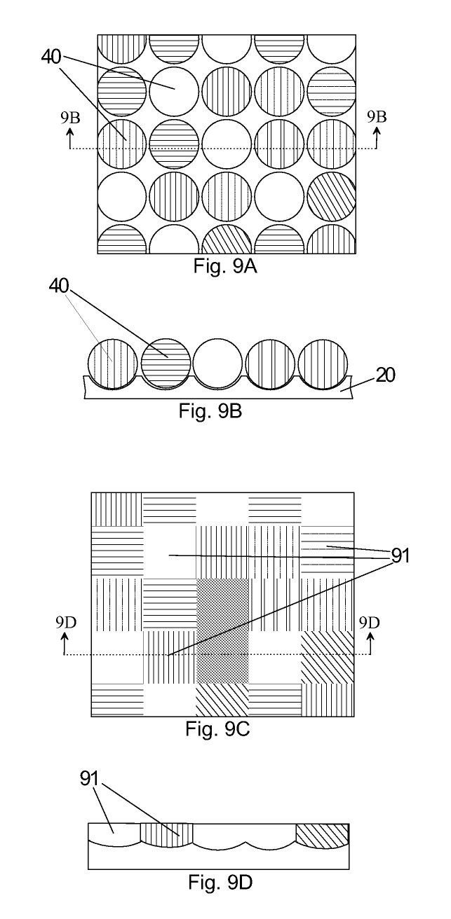

### Using a Rectangular Grid Base Sheet 20 and Ball Preforms 40 to Create a Fused Glass Object Having a Pattern of Square Elements. (FIGS. 9A Through 9D)

FIGS. 9A and 9B show a sections of a rectangular grid preform 20 having all the indentations filled with ball preforms 40. When this arrangement is fused into a glass object it will have a mosaic pattern of square elements 91 shown in FIGS. 9C and 9D. The square elements in the mosaic could be either flat or domed forming lenses depending on the temperature profile used in fusing.

Since adjacent ball preforms of the same color fuse together seamlessly, grouping ball preforms of the same color together in the layout results in larger mosaic elements.

### EXAMPLE 1.4

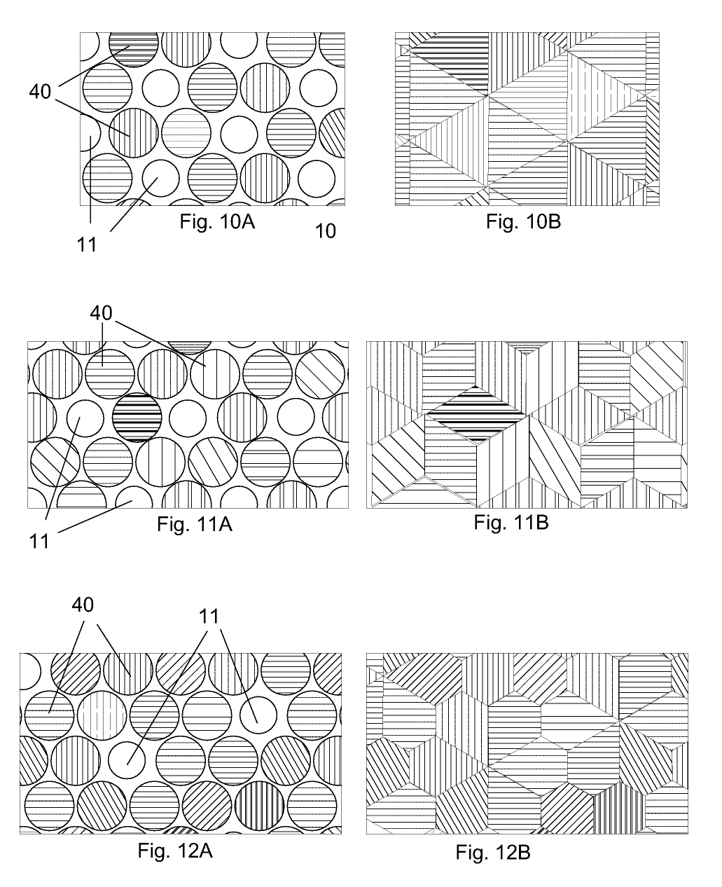

### Using a Hexagonal Grid Base Sheet and Ball Preforms to Create a Fused Glass Object Having Mosaic Elements with Other Shapes Such as Triangles, Diamonds or Pentagons. (FIGS. 10A, 10B, 11A, 11B, 12A and 12B)

Using the same glass preform shapes as above, a hexagonal grid base sheet 10 and ball preforms 40, patterns with different shaped mosaic elements can be made by using “missing ball patterns” (leaving selected indentations empty in the layout process). Regular patterns of triangle, diamond, and pentagon shapes can be made in this manner. In the figures the smaller circles 11 are the empty indentations not covered by ball preforms.

Sections of missing ball patterns layouts and the mosaic pattern created by fusing these arrangements together are shown in: FIGS. 10A and 10B for a pattern of equilateral triangles, FIGS. 11A and 11B for a pattern of diamonds (parallelograms), and FIGS. 12A and 12B for a pattern of pentagons.

Missing ball techniques can also be used with rectangular grid base sheets.

### EXAMPLE 1.5

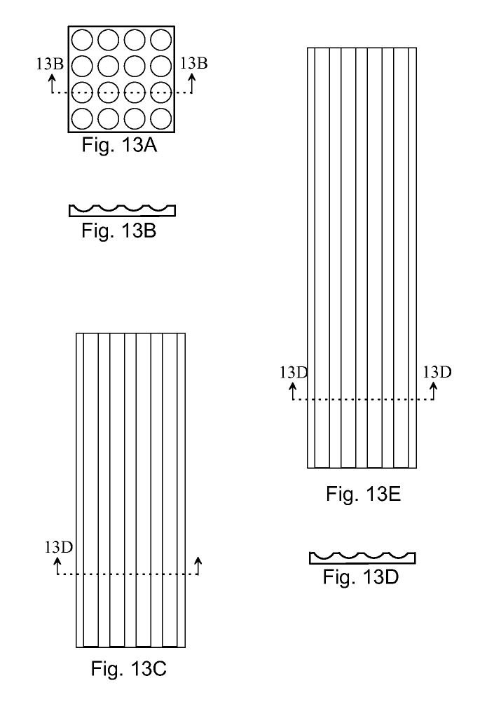

### Creating a Fused Glass Picture Frame Using Multiple Base Sheet Preforms. (FIGS. 13, 14, 15, 16, 17, 18 and 19)

This example illustrates how multiple base sheets can be use in a fused glass project. It uses four identical square shaped, rectangular grid base sheet approximately 25 mm on a side (FIGS. 13A and 13B) and four rectangular parallel trough base sheets (FIGS. 13C and 13E) approximately 25 mm wide. A cross section of the parallel trough base sheets is shown in FIG. 13D. Two of the parallel trough base sheets (FIGS. 13C) are 75 mm long and two (FIGS. 13E ) are 100 mm long.

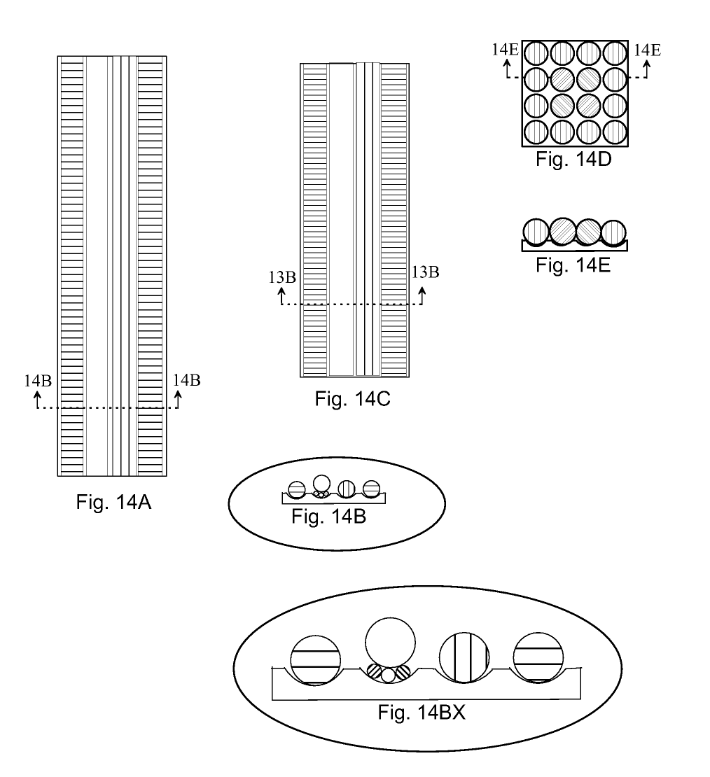

Each of the four rectangular pattern base sheets are filled with balls as illustrated in FIGS. 14D and 14E. Each of the parallel trough base sheets are filled end to end with rods as shown in cross section FIG. 14B and expanded view of the cross section 14BX. Note that the thin rod preforms are capped by a clear thick rod preform to obtain approximately 6 mm thickness.

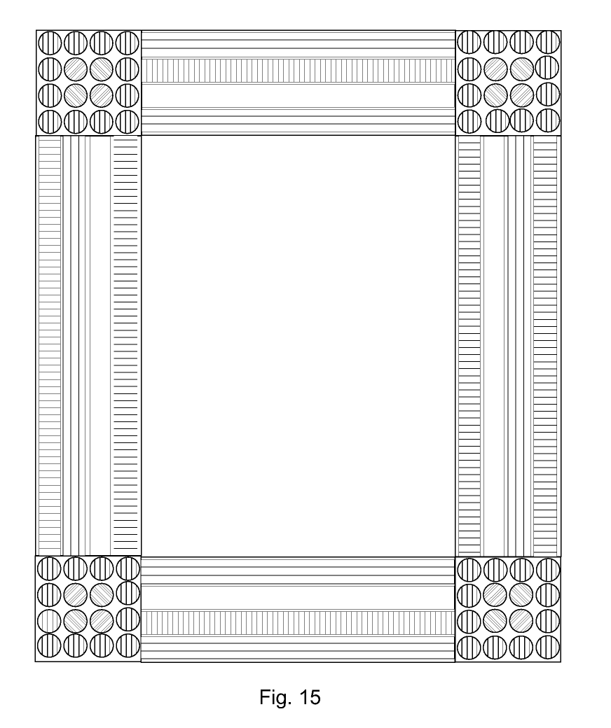

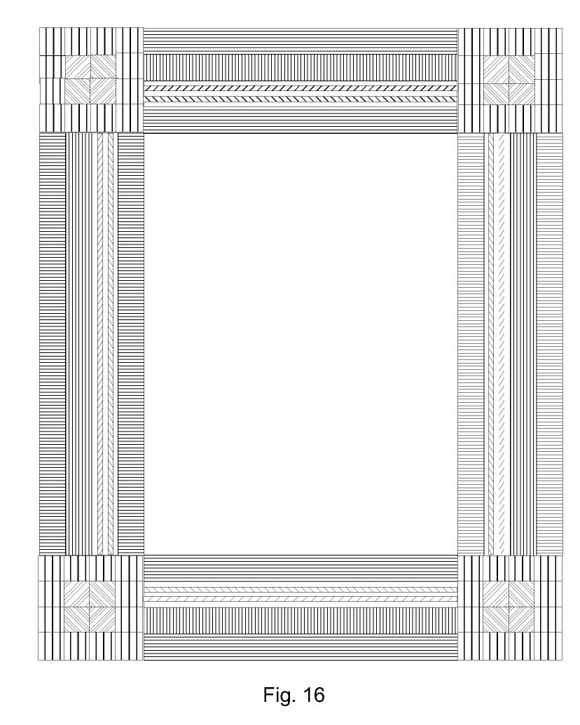

These base sheets with their color design preforms are then positioned together in the kiln as shown in FIG. 15. This arrangement of preforms is fused together to obtain a fused glass picture frame (FIG. 16).

Note that the base sheet preforms fuse together with their neighboring base sheets where they abut as well as with the color design preforms. This fusing together of base sheets opens a wide range of possibilities to the fused glass designer.

### Embodiment 2

### Standard Project Base Sheet and Color Design Preforms

Standard project base sheets have a fixed outline and patterns of indentations. They give the user the choice of colors to be used in each indentation. Standard project base sheets are intended for use in classes or popular projects requiring a standard shape like the panes for a standard stained glass lamp shade. They eliminate the need for cutting glass.

### EXAMPLE APPLICATION 2.1

### Standard Project Base Sheet Used to Make Fused Glass Picture Frame

The example standard base sheet illustrated in FIG. 17 results in the same design (FIG. 16) as example 1.5 above. In this case however a single base sheet (FIG. 17) with multiple patterns of indentations is used instead of 8 base sheets.

### EXAMPLE 2.2

### Small Diamond Shaped Base Sheet with Raised Edges

A small hexagonal grid raised edge base sheet is shown in FIG. 21. Note the raised edge shapes 181 illustrated in the cross section view (FIG. 18B). These raised and rounded edge base sheets result in:
(a) more robust base sheet.
(b) easier handling of laid out designs because the raised edges help constrain the ball preforms better.
(c) relatively straight edges after fusing
(d) less distortion of the mosaic elements at the edges during fusing. The raised edges constrain the balls on the outside edges during fusing.

### EXAMPLE 2.3

### Standard Base Sheet Tiles with Mating Edges

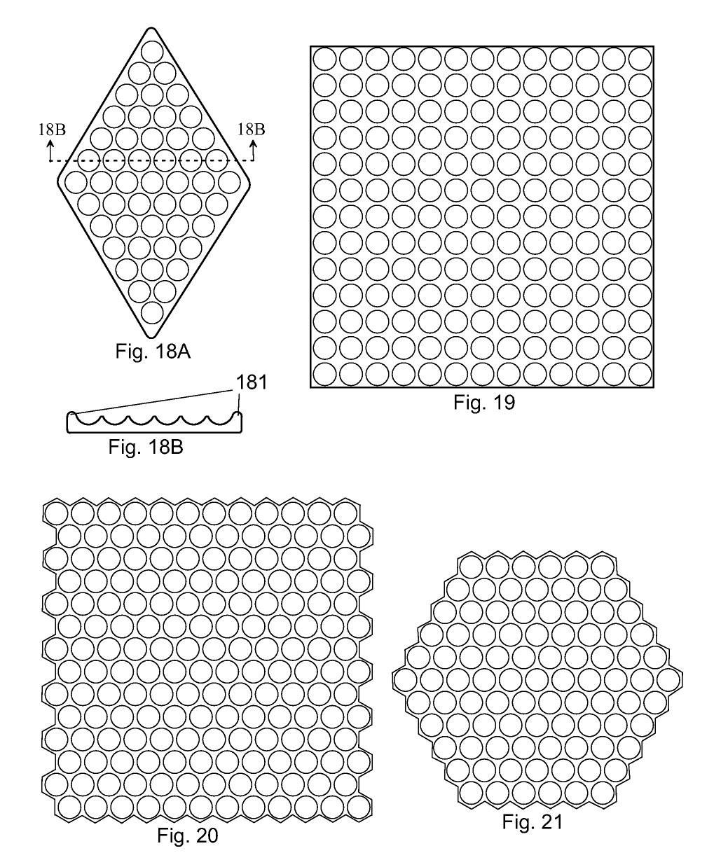

Base sheet preforms designed to fit together along their edges so as to continue the pattern of indentation will be called base sheet tiles. A base sheet tile with a rectangular grid indentation pattern have straight edges as shown in FIG. 19. Base sheet tiles with a hexagonal pattern of indentations will have zig-zag edges as shown in FIGS. 20 and 21. Note the two different edge shapes in FIG. 20. Each of the tiles illustrated can be arrayed with like tiles.

Since base sheet tiles will fuse together if abutted in the kiln, such tiles could be used abutting one another, instead of a single larger base sheet to make a fused glass object.

If standard base sheet tiles, after adding the color design preforms are constrained along their edges by edge molds during fusing, they will maintain their perimeter shape. Such fused tiles could be arranged after fusing abutting each other to form large mosaic designs. This facilitates making fused glass designs larger than the size of the available kiln for fusing them. This would facilitate, for example, making a glass mosaic design of small mosaic elements covering an entire wall.

### Embodiment 3

### Using Flat Glass Color Design Preforms with Base Sheet Preforms Having Flat Indentations

Often fused glass designs are desired with larger shaped element. Since the predictability of melted glass flow depends on the distance it must flow, making predictable large mosaic patterns, that are not combinations of the smaller patterns, requires a different approach. Larger mosaic shapes can be achieved by using flat color glass preforms with the approximate outlines of shapes desired and a base sheet with indentations into which these color design preforms can be placed. The indentations being of the same shape as the color design preforms and slightly larger. Indentations can also be made so as to position more than one color design preform.

Such preforms can be made for any shapes that can form mosaic patterns. The artist Escher used a wide variety of such shapes in his artwork.

### EXAMPLE 3.1

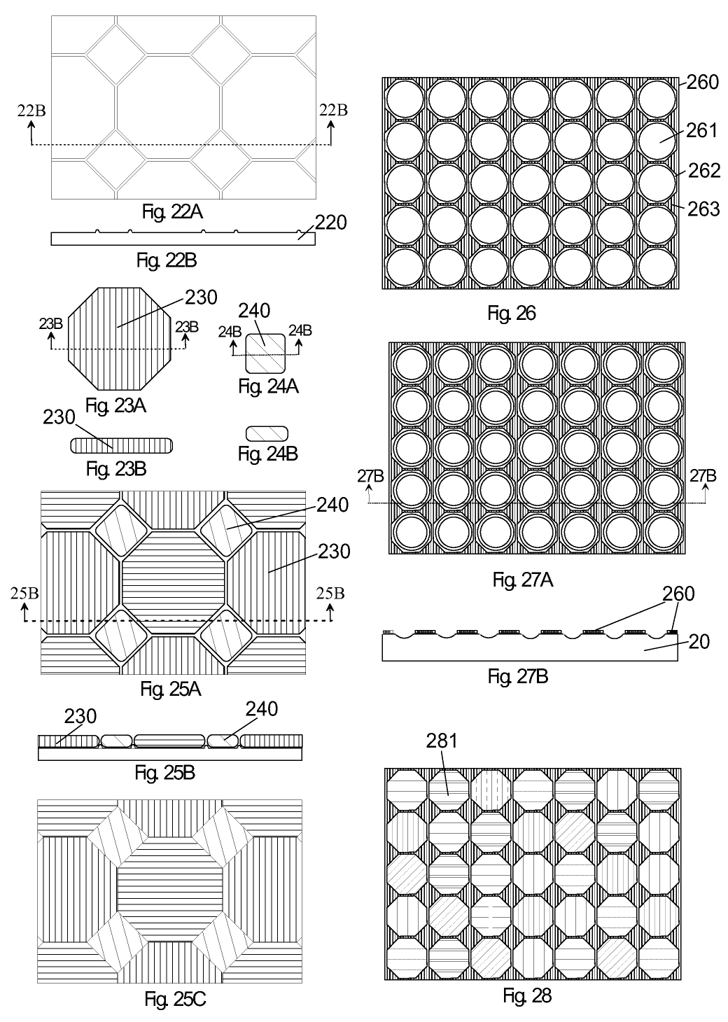

### Flat Glass Color Design Preforms for Making a Traditional Octagonal and Square Mosaic (FIGS. 22A to 25C)

FIG. 22A and cross section 22B show a base sheet preform with flat shallow indentations. FIG. 23A and cross section 23B shows a flat octagonal color glass preform 230. FIG. 24A and cross section 24B shows a flat square color glass preform with rounded edges. FIG. 25A and cross section 25B shows color glass preforms placed in the base sheet preform. Fusing this arrangement results in the glass object is shown in FIG. 25C.

### Embodiment 4

### Embodiment to Create Mosaic Patterns in Fused Glass with the Individual Elements Separated by a Grouting Like Pattern Outlining and Separating the Individual Elements

Mosaic patterns have a different visual impact when the elements are separated by a “grouting” like contrasting color in the fused glass. The effect is most striking when the elements are back lighted and the grouting is opaque. Grouting effects can be achieved by using a preform with coloring pigment or by printing the coloring pigment on the base sheet preform.

### EXAMPLE 4.1

### Creating a Grouted Mosaic Design of Octagonal Elements Using a Rectangular Grid Base Sheet Preform, a Grouting Preform, and Ball Preforms

A section of a rectangular grid grouting preform 260 is shown in FIG. 26. This pattern is designed to produce octagonal “grouting”. The hatched part of the pattern 263 represents the part of the preform with coloring pigment. The carrier without such coloring pigment 262 should not color the fused object. Note the holes 261 to permit the placement of ball preforms when they are aligned with the indentations in a rectangular grid base sheet 20.

The arrangement of the grouting preform over a rectangular grid base sheet is shown in FIGS. 27A and 27B. Adding balls and fusing a results in a fused glass object having a pattern like FIG. 28. Note that placing the balls in the indentations will help position the grouting preform and keep it positioned.

Thin metallic preforms could also be used with or without the carrier. Metallic preforms could also provide the additional benefits of wired glass.

### Embodiment 5

### Design Sheets to Plan Designs and Layout Color Glass Preforms

Using a design sheet and colored inks, paints or pencils one can plan a fused glass design by coloring in the shapes on the design sheet. This can then be used in the layout process to place the color design preforms in the layout needed to the achieve the design. An overlay sheet can be used to make the layout more visually correct.

### EXAMPLE 5.1

### Design Sheet and Layout Overlay to Support the Planning and Layout of Hexagonal Grid Base Sheet and Ball Preform Design. (FIGS. 29A to 31)

FIG. 29A shows a hexagonal grid design sheet. The designer colors in the hexagons with the colors for the planned design. A colored in design sheet is shown in FIG. 29B. In this figure the hatching patterns represent the colors chosen by the designer.

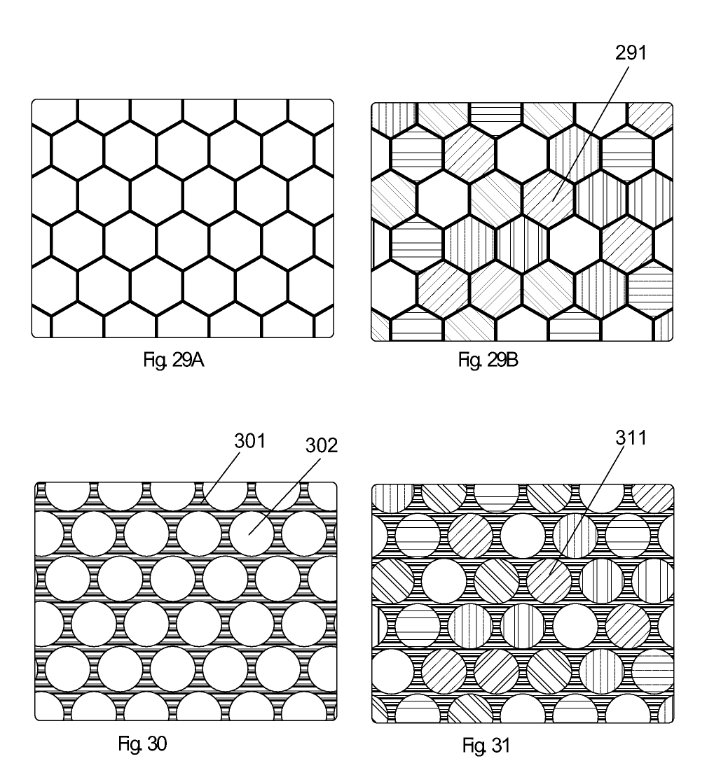

A layout overlay sheet is shown in FIG. 30. The hatching 301 indicates the opaque part of the overlay sheet. The clear circles 302 the transparent parts. These could either be cut out or made of clear material. When this layout sheet is placed over the planning sheet the circles of color show through. The colored circles show where to place the color ball preform.

If a design sheet with the correct scale is placed under a clear base sheet, with or without a layout overlay, the colors to be placed in each indentation will show through the base sheet. This can make layout easier and reduce layout errors.

Design sheets along with predictability of fused results using preforms makes it possible to separate the design and manufacturing processes. The design can be done in one location and layout and fusing done at a different location.

### CONCLUSIONS, RAMIFICATIONS, AND SCOPE

Accordingly, the reader will see the coordinated preforms of this invention can provide additional possibilities for the advanced fused glass artist as well as open the field of fused glass design to a wider range of novices. Using these preforms offers advantages in that
a wide range of fused glass patterns can be obtained predictably;
fused glass designs can be laid out without cutting glass or handling glass with sharp edges;
the design and production of decorative fused glass can be separated;
complex fused glass mosaic patterns are easily achieved;
a wide variety of fused glass visual effects can be achieved with a limited number of preforms;
fused glass objects can be designed using standardized design sheets;
multiple complex fused glass objects with the same design can be made easily.

Although the descriptions above contain many specificities, these should not be construed as to limiting the scope of the invention but merely providing illustrations of some of the presently preferred embodiments of this invention and their use. For example, the patterns of indentations in base sheets could be modified in a variety of ways to create other patterns, and a variety of different shapes of color preforms and matching indentations in base sheets could be used. Substituting a different shape for the ball preform, or a different extruded shape for the rod preform would yield substantially the same results. Truncated extruded shapes, with or without rounded ends, as well as ovoids and balls with a flattened side would all work well in place of ball preforms. Most would even form lense shapes as in example 1.2.

The term colored glass as used above includes water clear glass, as well as transparent, translucent, and opaque glass in white, black and other colors. Base sheet could be made with clear or colored glass.

I claim:

1. A coordinated set of preforms consisting of glass base sheet preforms in the shape of a relatively flat sheet with indentations on one side and smaller glass color design preforms. The indentations in the base sheet preforms being dimensioned to hold color design preforms in position by gravity when they are placed in the indentations of a relatively level base sheet preform. Said base sheet preform and said color design preforms being made of glass compositions with a specified compatible COE (coefficients of expansion). Said color design preforms being made of glass in variety of colors. These preforms are to be used for creating decorative fused glass objects by placing color design preforms in some or all of the indentations of the base sheet preform, and then fusing with heat, this arrangement into a unified fuse glass object.

2. The base sheet preforms and color design preforms of claim 1 whereas the base sheet preform has a regularly repeating patterns of indentations.

3. The base sheet preforms and color design preforms of claim 2 where the color design preforms are lumps of glass of approximately the same size and shape.

4. The base sheet preforms and color design preforms of claim 3 where the color design preforms have approximate rotational symmetry about at least one axis.

5. The base sheet preforms and color design preforms of claim 4 where the color design preforms are balls (roughly spherical lumps of glass).

6. The base sheet preforms and color design preforms of claim 3 with the base sheet preform having indentations arranged in a rectangular grid.

7. The base sheet preforms and color design preforms of claim 3 with the base sheet preform having alternating rows of indentations offset from each other.

8. The base sheet preforms and color design preforms of claim 7 with the indentations in the base sheet preform arranged so that indentations are approximately equidistant from their nearest six neighbors except at the edges of the base sheet.

9. The base sheet preforms and color design preforms of claim 3 where the edges of the base sheet will mate abutting with base sheets of like outline so as to continue the pattern of indentation.

10. The base sheet preforms and color design preforms of claim 3 with the base sheet of glass having a pattern printed on it. This pattern being printed in a material that will result in colors being imparted to the fused product. The pattern being intended to produce in the fused product a grouting like border between the fused mosaic elements.

11. The base sheet preforms and color design preforms of claim 3 with the addition of a thin preform used to create grouting like lines or shapes in the fused result.
This preform being constructed so that it can be placed on the base sheet preform without preventing the placement of color design preforms.

12. The base sheet preforms and color design preforms of claim 2 where the indentation are elongated troughs and the color design preforms are elongated shapes that can be positioned by placing them in the troughs.

13. The base sheet preforms and color design preforms of claim 12 where the troughs are evenly spaced and parallel.

14. The base sheet preforms and color design preforms of claim 1 where the base sheet has a variety of indentation shapes to accommodate a variety of color design preforms shapes.

15. The base sheet preform and color design preforms of claim 1 where some or all of the indentations in said base sheet totally penetrate the base sheet forming holes.

16. The base sheet preform and color design preforms of claim 1 with of a fixed size and outline shape for producing fused glass objects of a fixed size and shape.

17. The base sheet preform and color design preforms of claim 16 having a raised edge designed to add strength and minimize undesired distortion of the elements near the edge when fusing.

18. A process for making decorative fused glass objects using a coordinated set of preforms consisting of glass base sheet preforms in the shape of a relatively flat sheet with indentations on one side and smaller glass color design preforms. The process consists of first placing color design preforms in some or all of the indentations of the base sheet preform, and then fusing this arrangement, with heat, into a unified fuse glass object. The indentations in the base sheet preforms being dimensioned and positioned to hold color design preforms in known relative positions by gravity when they are placed in the indentations of a relatively level base sheet preform. Said color design preforms, being made of glass in variety of colors to provide color differences in the fused object. Said base sheet preforms and said color design preforms being made of glass compositions with a specified compatible COE (coefficient of expansion)

19. The process of claim 18 where the indentations in each base sheet are arranged in a regularly repeating pattern and the color design preforms placed in each base sheet have approximately the same size and shape.

20. Design sheet for planning the color design of a fused glass object to be made using preforms. Said design sheet having outlines for the fused glass shapes to be created and an optional overlay sheet blocking out some of the design area so as to show the layout arrangement in the shapes of the preforms to be used.
